(19) United States
(12) Patent Application Publication
(10) Pub. No.: US 2014/0233794 A1
(43) Pub. Date: Aug. 21, 2014

(54) METHOD, APPARATUS AND MEDICAL IMAGING SYSTEM FOR TRACKING MOTION OF ORGAN

(71) Applicant: Samsung Electronics Co., Ltd., Suwon-si (KR)

(72) Inventors: Young-taek OH, Seoul (KR); Sun-kwon KIM, Suwon-si (KR); Do-kyoon KIM, Seongnam-si (KR); Jung-bae KIM, Hwaseong-si (KR); Won-chul BANG, Seongnam-si (KR); Young-kyoo HWANG, Seoul (KR)

(73) Assignee: Samsung Electronics Co., Ltd., Suwon-si (KR)

(21) Appl. No.: 14/078,822

(22) Filed: Nov. 13, 2013

(30) Foreign Application Priority Data
Feb. 21, 2013 (KR) 10-2013-0018840

(51) Int. Cl. G06T 7/20; G06T 7/00

(52) U.S. Cl. CPC G06T 7/20; G06T 7/0012
USPC 382/103

(57) ABSTRACT

A method of tracking motion of an organ, includes receiving organ shape data that includes a shape of an organ of an examinee at a moment of motion of the examinee, and loading first to Nth interpolation curves that represent spatiotemporal motion of respective organs of other examinees, the organs of the other examinees being the same type as the organ of the examinee. The method further includes estimating an interpolation curve that represents a spatiotemporal motion of the organ of the examinee based on the first to Nth interpolation curves and the organ shape data.

### CROSS-REFERENCE TO RELATED APPLICATION

This application claims the benefit under 35 USC 119(a) of Korean Patent Application No. 10-2013-0018840, filed on Feb. 21, 2013, in the Korean Intellectual Property Office, the entire disclosure of which is incorporated herein by reference for all purposes.

### BACKGROUND

1. Field

The following description relates to methods, apparatuses, and medical imaging systems for tracking motion of organs.

2. Description of Related Art

Motion of organs makes it difficult to perform treatment on correct positions, and degrades the accuracy of preset treatment plans. In particular, although a non-invasive treatment, such as HIFU, has been widely-used with the development of high-quality medical imaging technology, the motion of the organs degrades the accuracy of the non-invasive treatment, and thus, a patient may be put in danger. Accordingly, tracking the motion of the organs with high accuracy is needed.

In general, a plurality of images of shapes of organs is acquired at every moment of motion of a patient, and motion of the organs due to the motion of the patient may be tracked using the acquired images. However, in order to acquire the plurality of images of the shapes of organs, a patient is more frequently exposed to a contrast medium or radiation, and more time and effort are needed. Therefore, efficiently tracking the motion of the organs while minimizing the exposure to a contrast medium or radiation is needed.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method of tracking motion of an organ, includes receiving organ shape data that includes a shape of an organ of an examinee at a moment of motion of the examinee, and loading first to Nth interpolation curves that represent spatiotemporal motion of respective organs of other examinees, the organs of the other examinees being the same type as the organ of the examinee. The method further includes estimating an interpolation curve that represents a spatiotemporal motion of the organ of the examinee based on the first to Nth interpolation curves and the organ shape data.

The estimating of the interpolation curve may include mapping the shape of the organ at the moment of the motion of the examinee, to a point in an M-dimensional spatiotemporal space, calculating weights of respective points of the first to Nth interpolation curves based on respective distances from the mapped point to the points in the M-dimensional spatiotemporal space, and estimating the interpolation curve from the mapped point based on the weights.

The estimating of the interpolation curve may include calculating first-order to nth-order differential values of the respective points of the first to Nth interpolation curves, calculating first-order to nth-order differential values of the mapped point based on the first-order to nth-order differential values of the respective points and the weights, and estimating the interpolation curve based on the first-order to nth-order differential values of the mapped point.

The estimating of the interpolation curve may include calculating control vectors that connect control points of the respective first to Nth interpolation curves, calculating a control vector of the interpolation curve based on the control vectors of the first to Nth interpolation curves and the weights, and estimating the interpolation curve based on the control vector of the interpolation curve.

The mapping of the shape of the organ may include representing the shape of the organ at the moment of the motion of the examinee, as a linear combination of an M number of basis functions, obtaining vector coefficients of each of the M number of the basis functions, and representing combinations of the vector coefficients as the point in the M-dimensional spatiotemporal space.

The basis functions may include spherical harmonics.

The method may further include obtaining the first to Nth interpolation curves based on first to Nth organ motion data that include the motion of the respective organs of the other examinees based on motion of the respective other examinees.

The motion of the examinee may be respiration, and the motion of the respective organs of the other examinees based on motion of the respective other examinees may be deformation of the respective organs of the other examinees based on respiration of the respective other examinees.

A non-transitory computer-readable storage medium may store a program including instructions to cause a computer to perform the method.

In another general aspect, a device configured to track motion of an organ, includes an interface unit configured to receive organ shape data that includes a shape of an organ of an examinee at a moment of motion of the examinee, and a storage device configured to store first to Nth interpolation curves that represent spatiotemporal motion of respective organs of other examinees, the organs of the other examinees being the same type as the organ of the examinee. The device further includes a motion tracking unit configured to estimate an interpolation curve that represents a spatiotemporal motion of the organ of the examinee based on the first to Nth interpolation curves and the organ shape data.

The motion tracking unit may include a first mapping unit configured to map the shape of the organ at the moment of the motion of the examinee, to a point in an M-dimensional spatiotemporal space, and an estimation unit configured to calculate weights of respective points of the first to Nth interpolation curves based on respective distances from the mapped point to the points in the M-dimensional spatiotemporal space, and estimate the interpolation curve from the mapped point based on the weights.

The motion tracking unit may further include a calculation unit configured to calculate first-order to nth-order differential values of the respective points of the first to Nth interpolation curves. The estimation unit may be configured to calculate first-order to nth-order differential values of the mapped point based on the first-order to nth-order differential values of the respective points and the weights, and estimate the interpolation curve based on the first-order to nth-order differential values of the mapped point.

The motion tracking unit may further include a calculation unit configured to calculate control vectors that connect control points of the respective first to Nth interpolation curves. The estimation unit may be configured to calculate a control vector of the interpolation curve based on the control vectors of the first to Nth interpolation curves and the weights, and estimate the interpolation curve based on the control vector of the interpolation curve.

The first mapping unit may be configured to represent the shape of the organ at the moment of the motion of the examinee, as a liner combination of an M number of basis functions, obtain vector coefficients of each of the M number of basis functions, and represent combinations of the vector coefficients as the point in the M-dimensional spatiotemporal space.

The motion tracking unit may include a matching unit configured to match organ deformation data that include a three-dimensional shape of the organ of the examinee that deforms over time, to an image of the organ of the examinee. The interface unit may be configured to receive the image of the organ of the examinee, and the motion tracking unit may be further configured to obtain the organ deformation data based on the interpolation curve, and track the motion of the organ of the examinee based on an image obtained as a result of the matching.

The device may further include a motion analysis unit configured to obtain the first to Nth interpolation curves based on first to Nth organ motion data that include the motion of the respective organs of the other examinees based on motion of the respective other examinees. Each of the first to Nth organ motion data may include a series of pieces of organ shape data that include shapes of an organ of one of the other examinees at respective moments of motion of the one of the other examinees.

The motion analysis unit may include a second mapping unit configured to map shapes of the respective organs at moments of the motion of the other examinees, included in the first to Nth organ motion data, to respective points in an M-dimensional spatiotemporal space, and an interpolation unit configured to obtain the first to Nth interpolation curves by interpolating the respective mapped points.

The second mapping unit may be configured to represent the shapes of the respective organs at the moments of the motion of the other examinees, as respective linear combinations of an M number of basis functions, obtain vector coefficients of each of the M number of basis functions, and represent combinations of the vector coefficients as the respective points in the M-dimensional spatiotemporal space.

In still another general aspect, a medical imaging device includes an image acquisition device configured to acquire an image of a shape of an organ of an examinee at a moment of motion of the examinee. The medical imaging device further includes an organ tracking device configured to store first to Nth interpolation curves that represent spatiotemporal motion of respective organs of other examinees, the organs of the other examinees being the same type as the organ of the examinee, estimate an interpolation curve that represents a spatiotemporal motion of the organ of the examinee based on the first to Nth interpolation curves and the image, and obtain organ deformation data that include a three-dimensional (3D) shape of the organ of the examinee that deforms over time based on the interpolation curve. The medical imaging device further includes an image display device configured to display the 3D shape of the organ based on the organ deformation data.

Other features and aspects will be apparent from the following detailed description, the drawings, and the claims.

### BRIEF DESCRIPTION OF THE DRAWINGS

FIG. 1 is a diagram illustrating an example of a medical imaging system that tracks motion of an organ of an examinee.

FIG. 2 is a block diagram illustrating an example of an organ tracking device.

FIG. 3 is a block diagram illustrating an example of a motion tracking unit.

FIG. 4 is a block diagram illustrating another example of an organ tracking device.

FIG. 5 is a block diagram illustrating an example of a motion analysis unit.

FIG. 6 is a diagram illustrating an example of first to Nth interpolation curves representing respective spatiotemporal paths of motion of organs of a plurality of examinees.

FIG. 7 is a diagram illustrating an example of control points of an interpolation curve and control vectors that connect the control points.

FIG. 8 is a flowchart illustrating an example of a method of tracking motion of an organ.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the systems, apparatuses and/or methods described herein will be apparent to one of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

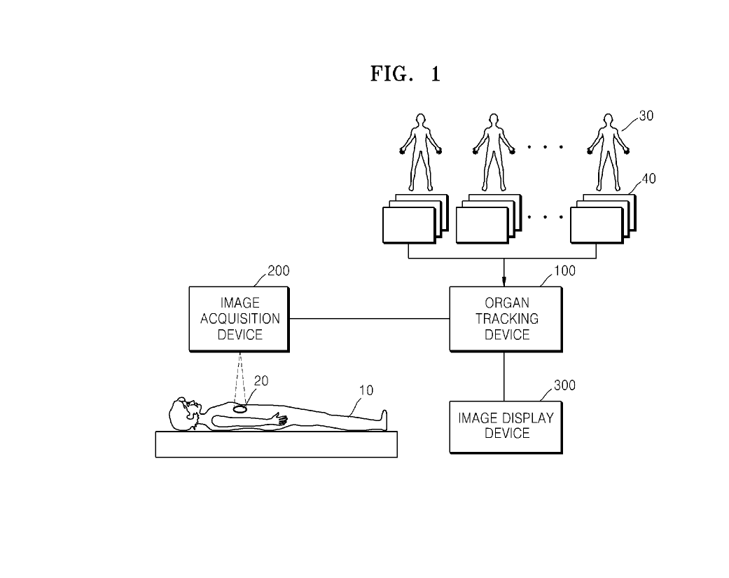

FIG. 1 is a block diagram illustrating a medical imaging system that tracks motion of an organ 20 of an examinee 10. Referring to FIG. 1, the medical imaging system includes an organ tracking device 100, an image acquisition device 200, and an image display device 300.

The medical imaging system of FIG. 1 tracks the motion of the organ 20 that depends on motion of the examinee 10, using an image of a shape of the organ 20 that is obtained by the image acquisition device 200. For example, if the motion of the examinee 10 is respiration of the examinee 10, and the organ 20 of the examinee 10 is a liver, the liver of the examinee 10 regularly moves depending on the respiration of the examinee 10. The organ tracking device 100 may track the motion of the organ 20 due to the respiration of the examinee 10, using an image of a shape of the organ 20 that is obtained at a moment of the respiration of the examinee 10. The moment of the respiration may be inhalation, exhalation, or half inhalation. The organ 20 that is a target of tracking is exemplified as a liver in the example of FIG. 1, but is not limited thereto. Motion of various organs other than a liver may also be tracked.

The image acquisition device 200 acquires an image of a shape of the organ 20 that is captured at a moment of motion of the examinee 10. The acquired image may be a computed tomography (CT) image, an X-ray image, an ultrasonic image, or a magnetic resonance (MR) image of the organ 20, but is not limited thereto. The image acquisition device 200 transmits the acquired image of the shape of the organ 20 of the examinee 10 to the organ tracking device 100.

The organ tracking device 100 tracks the motion of the organ 20 of the examinee 10, using the image of the organ 20 of the examinee 10 and first to Nth interpolation curves obtained for respective organs of a plurality of examinees 30 other than the examinee 10. The organs of the examinees 30 are the same type as the organ 20. In more detail, in order to track the motion of the organ 20 of the examinee 10, the organ tracking device 100 uses organ shape data of the examinee 10 that is obtained from the image of the organ 20 of the examinee 10. The organ shape data indicates the shape of the organ 20 that is obtained at the moment of the motion of the examinee 10.

The first to Nth interpolation curves, which represent respective spatiotemporal paths of motion of the organs of the examinees 30, are stored in an internal or external storage device of the organ tracking device 100. The organ tracking device 100 loads the first to Nth interpolation curves from the storage device to track the motion of the organ 20 of the examinee 10, using the curves.

The first to Nth interpolation curves may be obtained using first to Nth organ motion data 40 of the organs of the examinees 30. The organ motion data 40 indicates shapes of the respective organs of the examinees 30, according to motion of the examinees 30. Each of the organ motion data 40 may include a series of pieces of organ shape data representing shapes of an organ of one of the examinees 30 at respective moments of motion of the one of the examinees 30.

The organ motion data 40 may represent shapes of the respective organs of the examinees 30 that are obtained at respective moments of respiration of the examinees 30. For example, the organ motion data 40 may be images of respective shapes of livers of the examinees 30 that are obtained at respective moments of inhalation, exhalation, and half inhalation of the examinees 30. That is, each of the organ motion data 40 may include a series of pieces of organ shape data representing shapes of a liver of one of the examinees 30 that are obtained at respective moments of respiration, which represents motion of the liver due to respiration.

The organ tracking device 100 tracks a spatiotemporal path of the motion of the organ 20 of the examinee 10 by estimating an interpolation curve of the examinee 10, using the first to Nth interpolation curves of the examinees 30. For example, the organ tracking device 100 may track the spatiotemporal path of the motion of the organ 20 of the examinee 10, using organ deformation data obtained based on the estimated interpolation curve of the examinee 10. The organ deformation data represents a 3D image of the organ 20 of the examinee 10, which deforms over time.

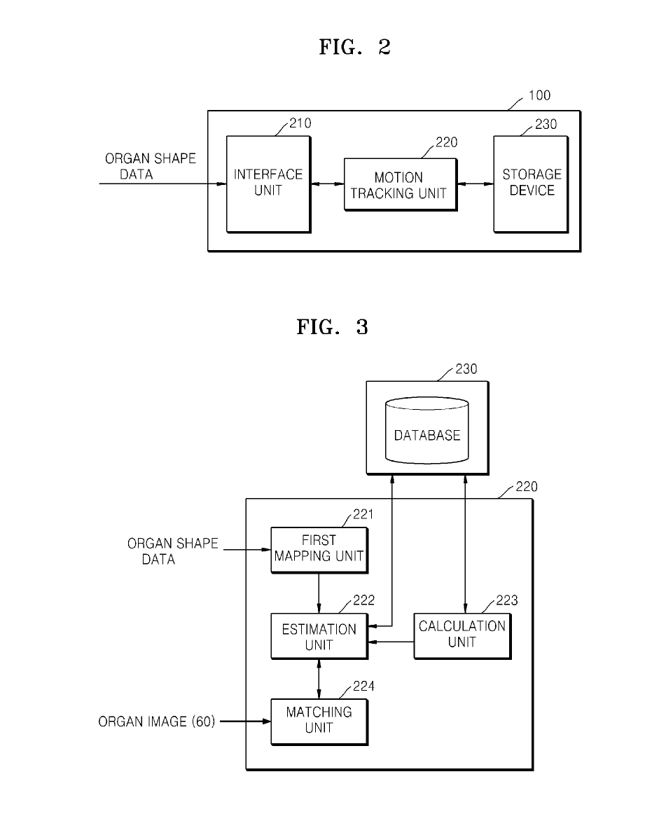

The organ tracking device 100 may store, in the storage device, the estimated interpolation curve of the examinee 10 and the organ deformation data obtained using the estimated interpolation curve. The organ deformation data stored in the storage device may be used for a non-invasive treatment for the examinee 10. In an example, the organ tracking device 100 loads prestored organ deformation data, and matches the organ deformation data to a two-dimensional image of the organ 20 of the examinee 10 that is captured during a treatment. The organ tracking device 100 may detect a correct position of a tumor to be removed, using an image obtained as a result of the matching. Although it has been described that the matching of an image is performed by the organ tracking device 100, the matching operation is not limited thereto. One of ordinary skill in the art understands that the matching of an image may be performed by another device other than the organ tracking device 100, such as a computer including an image matching function. Other detailed descriptions related to the organ tracking device 100 will be provided later with reference to FIG. 2 and the following drawings.

The image display device 300 displays the tracked motion of the organ 20 of the examinee 10 on a screen. For example, the image display device 300 may three-dimensionally display a 3D shape of the organ 20 that deforms over time, using the organ deformation data.

FIG. 2 is a block diagram illustrating an example of the organ tracking device 100. Referring to FIG. 2, the organ tracking device 100 includes an interface unit 210, a motion tracking unit 220, and a storage device 230.

FIG. 2 only illustrates components related to the example of the organ tracking device 100. Therefore, one of ordinary skill in the art understands that general components other than the components illustrated in FIG. 2 may be further included.

The organ tracking device 100 may correspond to or include at least one processor. Accordingly, the organ tracking device 100 may be included in a general computer system (not illustrated), and may operate therein.

The organ tracking device 100 tracks motion of the organ 20 of the examinee 10, using obtained spatiotemporal paths of respective motion of organs of the examinees 30.

The interface unit 210 receives organ shape data of the examinee 10, which represents a shape of the organ 20 that is obtained at a moment of motion of the examinee 10, the organ 20 being a target of organ motion tracking. The interface unit 210 transmits the received organ shape data to the motion tracking unit 220. The organ shape data may be an image of the organ 20 of the examinee 10. The interface unit 210 may receive the image of the organ 20 of the examinee 10 from the image acquisition device 200.

The interface unit 210 may receive information from a user, and may transmit/receive data to/from an external device via a wire/wireless network or wire serial communication. The network may include the Internet, a local area network (LAN), a wireless LAN, a wide area network (WAN), and/or a personal area network (PAN), but is not limited thereto. However, one of ordinary skill in the art understands that other types of networks that transmit/receive information may be used.

The storage device 230 stores first to Nth interpolation curves that represent the spatiotemporal paths of the respective motion of the organs of the examinees 30, the interpolation curves being obtained for the organs of the examinees 30 that are the same type as the organ of the examinee 10. For example, the first to Nth interpolation curves may be stored in the form of a database. The storage device 230 may be implemented with a hard disk drive (HDD), a read only memory (ROM), a random access memory (RAM), a flash memory, a memory card, and/or a solid state drive (SSD), but is not limited thereto.

The first to Nth interpolation curves stored in the storage device 230 may be obtained using the first to Nth organ motion data 40 that represent the motion of the respective organs of the examinees 30 due to respective motion of the examinees 30. Each of the first to Nth organ motion data 40 may include a series of pieces of organ shape data, which represent shapes of an organ of one of the examinees 30 that are obtained at respective moments of motion of one of the examinees 30.

When the organ shape data of the examinee 10 is received through the interface unit 210, the motion tracking unit 220 estimates an interpolation curve of the examinee 10 based on the first to Nth interpolation curves and the organ shape data of the examinee 10. The interpolation curve of the examinee 10 represents a spatiotemporal path of the motion of the organ 20 of the examinee 10. As described above, when organ shape data of a new examinee is inputted, the organ tracking device 100 tracks a spatiotemporal path of motion of an organ of the new examinee based on the organ shape data and spatiotemporal paths of respective motion of organs that are obtained from examinees.

FIG. 3 is a block diagram illustrating an example of the motion tracking unit 220. Referring to FIG. 3, the motion tracking unit 220 includes a first mapping unit 221, an estimation unit 222, a calculation unit 223, and a matching unit 224.

FIG. 3 only illustrates components related to the example of the motion tracking unit 220. However, one of ordinary skill in the art understands that general components other than the components illustrated in FIG. 3 may be further included. The motion tracking unit 220 illustrated in FIG. 3 may correspond to one or more processors.

The first mapping unit 221 maps a shape of the organ 20 of a moment of motion of the examinee 10, included in organ shape data, to a single point in an M-dimensional spatiotemporal space. In more detail, the first mapping unit 221 represents the shape of the organ 20 at the moment of the motion of the examinee 10 as a linear combination of M number of basis functions, acquires vector coefficients of each of the M number of the basis functions, and represents combinations of the vector coefficients of each of the M number of the basis functions as the single point in the M-dimensional spatiotemporal space. The linear combination of the basis functions may be represented using spherical harmonics, but other various basis functions may also be used without being limited to the spherical harmonics.

The mapping of the shape of the organ 20 at the moment of the motion of the examinee 10 to the single point in the M-dimensional spatiotemporal space by the first mapping unit 221 is similar as mapping shapes of respective organs of the examinees 30 at respective moments of motion of the examinees 30 to respective points in the M-dimensional spatiotemporal space by a second mapping unit 241. A detailed description of this operation is provided with reference to FIG. 5.

The estimation unit 222 receives the first to Nth interpolation curves from the storage device 230. The estimation unit 222 estimates the interpolation curve of the examinee 10 based on distances from the mapped point of the shape of the organ 20 of the examinee 10 to points of the first to Nth interpolation curves in the M-dimensional spatiotemporal space. For example, the estimation unit 222 may calculate weights based on the respective distances from the mapped point to the points of the first to Nth interpolation curves in the M-dimensional spatiotemporal space, and may estimate the interpolation curve of the examinee 10 from the mapped point based on the respective weights of the points of the first to Nth interpolation curves.

In an example, the motion tracking unit 220 may estimate the interpolation curve of the examinee 10 based on first-order to nth-order differential values of the respective points of the first to Nth interpolation curves. In more detail, the calculation unit 223 may calculate the first-order to nth-order differential values of the respective points of the first to Nth interpolation curves. The first-order to nth-order differential values of the respective points of the first to Nth interpolation curves may be stored with the first to Nth interpolation curves in the form of a database in the storage device 230. The estimation unit 222 may calculate first-order to nth-order differential values of the mapped point based on the weights and the first-order to nth-order differential values of the respective points of the first to Nth interpolation curves. For example, the estimation unit 222 may calculate the first-order to nth-order differential values of the mapped point by multiplying the first-order to nth-order differential values of the respective points of the first to Nth interpolation curves by the weights.

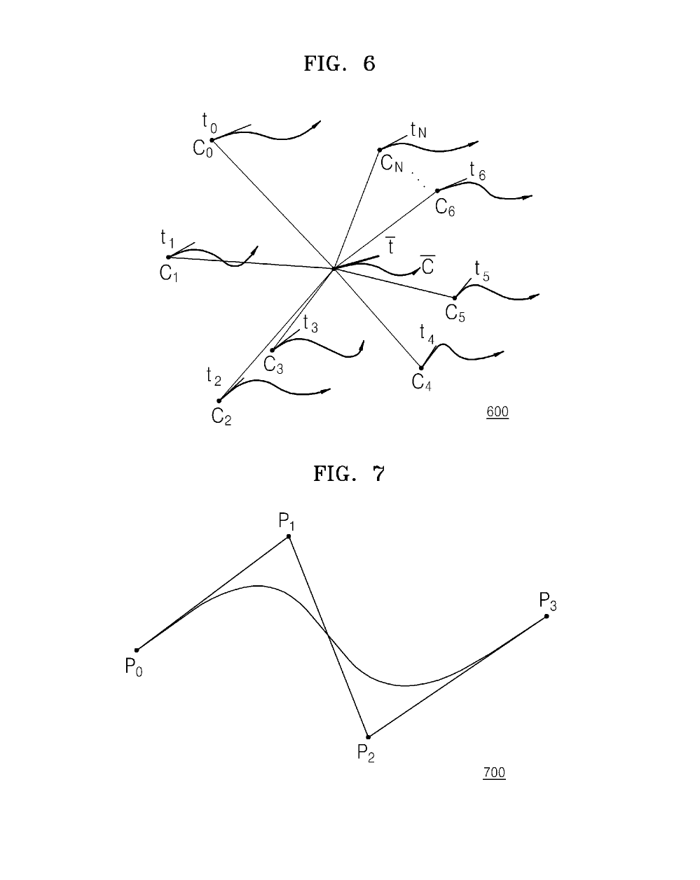

Accordingly, the estimation unit 222 may estimate the interpolation curve of the examinee 10 from the mapped point based on the first-order to nth-order differential values calculated from the mapped point. Further detailed descriptions will be provided with reference to FIG. 6.

In another example, the motion tracking unit 220 may estimate the interpolation curve of the examinee 10 based on control vectors that connect control points of the respective first to Nth interpolation curves. In more detail, the calculation unit 223 may calculate the control vectors of the first to Nth interpolation curves. The control vectors of the first to Nth interpolation curves may be stored with the first to Nth interpolation curves in the form of a database in the storage device 230. The estimation unit 222 may calculate a control vector of the interpolation curve of the examinee 10 based on the weights and the control vectors of the first to Nth interpolation curves.

In even more detail, the calculation unit 223 may calculate directions and magnitudes of the control vectors of the first to Nth interpolation curves. The estimation unit 222 may calculate a direction and a magnitude of the interpolation curve of the examinee 10 based on the directions and magnitudes of the control vectors of the first to Nth interpolation curves and based on the weights determined according to the respective distances, and then may calculate the control vector of the interpolation curve of the examinee 10 based on the calculated direction and magnitude of the interpolation curve.

Accordingly, the estimation unit 222 may estimate the interpolation curve of the examinee 10 from the mapped point based on the control vector of the interpolation curve of the examinee 10. Further detailed descriptions will be provided with reference to FIG. 7.

The matching unit 224 matches organ deformation data of the examinee 10 to an organ image 60 of the examinee 10. The organ deformation data is obtained from the interpolation curve of the examinee 10. Accordingly, the organ tracking device 100 may track spatiotemporal motion of the organ 20 of the examinee 10 by matching the organ deformation data of the examinee 10, which are three-dimensional data, to the organ image 60 of the examinee 10, which is two-dimensional data.

In more detail, the motion tracking unit 220 (namely, the estimation unit 222) acquires the organ deformation data that represent a 3D shape of the organ 20 of the examinee 10, which deforms over time, based on the estimated interpolation curve of the examinee 10. The matching unit 224 receives the organ image 60 of the examinee 10 from the interface unit 210, and receives the organ deformation data of the examinee 10 from the estimation unit 222. The matching unit 224 matches the organ deformation data of the examinee 10 to the organ image 60 of the examinee 10. Accordingly, the motion tracking unit 220 may track the spatiotemporal motion of the organ 20 of the examinee 10 based on an image obtained as a result of the matching, i.e., an image of the organ deformation data that matches the organ image 60.

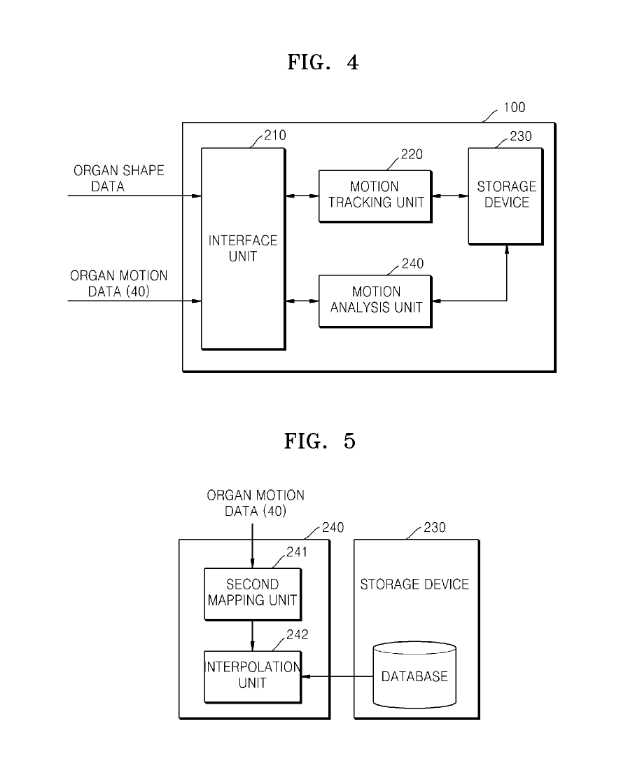

FIG. 4 is a block diagram illustrating another example of the organ tracking device 100. Referring to FIG. 4, the organ tracking device 100 further includes a motion analysis unit 240 in comparison with the organ tracking device 100 of FIG. 2. The interface unit 210, the motion tracking unit 220, and the storage device 230 illustrated in FIG. 4 are the same as the interface unit 210, the motion tracking unit 220, and the storage device 230, respectively, illustrated in FIG. 2. Therefore, the above descriptions provided in connection with FIGS. 2 and 3 are also applied to the organ tracking device 100 of FIG. 4.

The organ tracking device 100 may correspond to or include at least one processor. Accordingly, the organ tracking device 100 may be included in a general computer system (not illustrated), and may operate therein. The motion tracking unit 220 and the motion analysis unit 240 may be individual processors as illustrated in FIG. 4, but may be operated as a single processor.

The motion analysis unit 240 acquires first to Nth interpolation curves based on the first to Nth organ motion data 40. The first to Nth organ motion data 40, which are acquired from respective organs of the examinees 30, represent motion of the respective organs of the examinees 30 according to motion of the examinees 30. For example, each of the first to Nth organ motion data 40 may include a series of pieces of organ shape data that represent shapes of an organ of one of the examinees 30 that are obtained at respective moments of motion of the one of the examinees 30. In this example, the organ motion data 40 may be a plurality of images of the respective organs according to the motion of the examinees 30.

The organ tracking device 100 receives the organ motion data 40 from the image acquisition device 200. In more detail, the interface unit 210 receives the first to Nth organ motion data 40 from the image acquisition device, and transmits the first to Nth organ motion data 40 to the motion analysis unit 240.

The storage device 230 stores first to Nth interpolation curves acquired by the motion analysis unit 240. For example, the first to Nth interpolation curves may be stored in the form of a database.

When the interface unit 210 receives organ shape data of the examinee 10, the motion tracking unit 220 loads the first to Nth interpolation curves stored in the storage device 230. The motion tracking unit 220 estimates the interpolation curve of the examinee 10 based on the first to Nth interpolation curves and the organ shape data of the examinee 10.

FIG. 5 is a block diagram illustrating an example of the motion analysis unit 240. Referring to FIG. 5, the motion analysis unit 240 includes the second mapping unit 241 and an interpolation unit 242.

FIG. 5 only illustrates components related to the example of FIG. 5. Therefore, one of ordinary skill in the art understands that general components other than the components illustrated in FIG. 5 may be further included. The motion analysis unit 240 illustrated in FIG. 5 may correspond to one or more processors.

The second mapping unit 241 maps shapes of organs of the examinees 30 at respective moments of the motion of the examinees 30, to respective points in an M-dimensional spatiotemporal space based on a series of pieces of organ shape data included in each of the first to Nth organ motion data 40. In an example, the second mapping unit 241 may map the shapes of the organs at the respective moments of the motion of the examinees 30, included in the first to Nth organ motion data 40, to the respective points in the M-dimensional spatiotemporal space based on basis functions. The second mapping unit 241 may represent each of the shapes of the organs at the respective moments of the motion as a linear combination of M number of the basis functions. The linear combination of the M number of the basis functions may be represented using spherical harmonics, but other various basis functions may also be used without being limited to the spherical harmonics.

Hereinafter, for convenience of explanation, the spherical harmonics are used as the basis functions. Each of the shapes of the organs that is represented by spherical coordinates may be represented as the linear combination of M number of the basis functions based on the spherical harmonics, as shown in Equations 1 through 3 below.

$${Y}_{l}^{m} ( θ , φ ) = {( - 1 )}^{m} \sqrt{\frac{2 l + 1}{4 π}} \sqrt{\frac{( l - m ) !}{( l - m ) !}} {P}_{l}^{m} ( cos θ ) {e}^{i m φ} \qquad ( 1 )$$

In Equation 1, Y₁^{m}(θ, φ) represents the spherical harmonics. θ represents a polar angle between [0, π], and φ represents an azimuth angle between [0, 2π]. 1, which is an integer between [0, +∞], represents a harmonic degree, and m, which is an integer between [−1, +1], represents a harmonic order.

$$f ( θ , φ ) = {\sum }_{l = 0}^{∞} {\sum }_{m = - l}^{l} {a}_{l}^{m} {Y}_{l}^{m} ( θ , φ ) \qquad ( 2 )$$

In Equation 2, f(θ, φ) represents a shape of an organ. Accordingly, the organ shape f(θ, φ) may be represented as the linear combination of the spherical harmonics Y₁^{m}(θ, φ). Further, a₁^{m} represents coefficients of the spherical harmonics Y₁^{m}(θ, φ).

$$f ( θ , φ ) = {\sum }_{l = 0}^{L} {\sum }_{m = - l}^{l} {a}_{l}^{m} {Y}_{l}^{m} ( θ , φ ) \qquad ( 3 )$$

Equation 3 expresses the organ shape f(θ, φ) of Equation 2 as linear combinations of a finite number of the spherical harmonics Y₁^{m}(θ, φ). Combinations of a finite number of the coefficients a₁^{m} may be acquired for the linear combinations of the finite number of the spherical harmonics Y₁^{m}(θ, φ). The combinations of the finite number of the coefficients a₁^{m} may be represented as vector coefficients, such as a₀={a₀⁰,a₁⁻¹,a₁⁰, . . . }. Accordingly, the vector coefficients may be acquired for each of the M number of the basis functions.

The second mapping unit 241 acquires the vector coefficients of each of the M number of the basis functions, and represents combinations of the vector coefficients of each of the M number of the basis functions as the respective points in the M-dimensional spatiotemporal space. Accordingly, the second mapping unit 241 maps the shapes of the organs at the respective moments of the motion of the examinees 30, included in the first to Nth pieces of organ motion data 40, to the respective points in the M-dimensional spatiotemporal space.

The interpolation unit 242 interpolates the mapped points in the M-dimensional spatiotemporal space to thereby obtain the first to Nth interpolation curves. For example, the interpolation unit 242 may perform the interpolation based on a Bézier curve. However, another curve other than the bézier curve, such as B-spline, may be used for the interpolation. The first to Nth interpolation curves obtained by the interpolation unit 242 are stored in the storage device 230. For example, the first to Nth interpolation curves may be stored in the form of a database.

FIG. 6 is a diagram illustrating an example of first to Nth interpolation curves 600 representing respective spatiotemporal paths of motion of organs of the plurality of examinees 30. The first to Nth interpolation curves 600 are on an M-dimensional spatiotemporal space, and are represented as C₀ to C_{N}, respectively. One of ordinary skill in the art understands that the first to Nth interpolation curves 600 are expressed as illustrated in FIG. 6 for convenience of explanation. According to the operations of the second mapping unit 241 and the interpolation unit 242 described above in connection with FIG. 5, the first to Nth interpolation curves 600 may be expressed as illustrated in FIG. 6.

The organ tracking device 100 of FIGS. 2 and 3 may estimate an interpolation curve of the examinee 10 based on first-order to nth-order differential values of respective points of the first to Nth interpolation curves 600. In more detail, the motion tracking unit 220 may calculate the first-order to nth-order differential values of the respective points of the first to Nth interpolation curves 600. The motion tracking unit 220 may calculate first-order to nth-order differential values of a mapped point of a shape of an organ of the examinee 10 based on weights and the first-order to nth-order differential values of the respective points of the first to Nth interpolation curves 600. For example, as expressed in Equation 4 below, the motion tracking unit 220 may calculate the first-order to nth-order differential values of the mapped point by multiplying the first-order to nth-order differential values of the respective points of the first to Nth interpolation curves 600 by the respective weights obtained according to respective distances from the points of the first to Nth interpolation curves 600 to the mapped point.

t̅=w₀t₀+w₁t₁+w₂t₂+w₃t₃+ . . . +w_{N}t_{N} (4)

In Equation 4 and FIG. 6, t̅represents the first-order to nth-order differential values of the mapped point of the shape of the organ of the examinee 10. w_{i=0,1,2,3, . . . N} represents the weights according to the respective distances from the points of the first to Nth interpolation curves 600 to the mapped point. t_{i=0,1,2,3, . . . N} represents the first-order to nth-order differential values of the respective points of the first to Nth interpolation curves 600. That is, the first-order to nth-order differential values of the mapped point may be estimated by multiplying the first-order to nth differential values of the respective points of the first to Nth interpolation curves 600 by the weights, respectively, and then adding the weighted first-order to Nth-order differential values.

The motion tracking unit 220 may estimate the interpolation curve, which is represented as C̅, of the examinee 10 from the mapped point based on the estimated first-order to nth-order differential values of the mapped point of the shape of the organ of the examinee 10.

FIG. 7 is a diagram illustrating an example of control points of an interpolation curve 700 and control vectors that connect the control points. Only some of the control points are illustrated in the example for convenience of explanation, but the example is not limited thereto.

The organ tracking device 100 of FIGS. 2 and 3 may estimate the interpolation curve 700 of the examinee 10 based on the control vectors that connect the control points of respective first to Nth interpolation curves. In more detail, the motion tracking unit 220 may calculate the control vectors of the first to Nth interpolation curves. The motion tracking unit 220 may calculate a control vector of the interpolation curve 700 of the examinee 10 based on the control vectors of the first to Nth interpolation curves and weights. For example, as expressed in Equation 5 below, the motion tracking unit 220 may calculate the control vector of the interpolation curve 700 of the examinee 10 by calculating directions and magnitudes of the respective control vectors of the first to Nth interpolation curves, and using the calculated directions and magnitudes.

$$\{ \frac{{P}_{1} - {P}_{0}}{‖ {P}_{1} - {P}_{0} ‖} , ‖ {P}_{1} - {P}_{0} ‖ \} , \{ \frac{{P}_{2} - {P}_{1}}{‖ {P}_{2} - {P}_{1} ‖} , ‖ {P}_{2} - {P}_{1} ‖ \} , \{ \frac{{P}_{3} - {P}_{2}}{‖ {P}_{3} - {P}_{2} ‖} , ‖ {P}_{3} - {P}_{2} ‖ \} \qquad ( 5 )$$

In Equation 5, P₀, P₁, P₂, and P₃ represent the control points of the interpolation curve 700.

$$\{ \frac{{P}_{1} - {P}_{0}}{‖ {P}_{1} - {P}_{0} ‖} , ‖ {P}_{1} - {P}_{0} ‖ \}$$

represents a control vector that connects the controls points P₀ and P₁. In more detail,

$$\frac{{P}_{1} - {P}_{0}}{‖ {P}_{1} - {P}_{0} ‖}$$

represents a direction of the control vector that connects the control points P₀ and P₁, and ∥P₁−P₀∥ represents a magnitude of the control vector that connects the control points P₀ and P₁.

The motion tracking unit 220 may calculate a direction and a magnitude of the control vector of the interpolation curve 700 of the examinee 10 based on the direction and magnitude of each of the control vectors of the first to Nth interpolation curves and the weights determined according to respective distances from the control points of the respective first to Nth interpolation curves to a mapped point of a shape of an organ of the examinee 10. For example, as expressed in Equations 6 and 7 below, the motion tracking unit 220 may calculate the direction and magnitude of the control vector of the interpolation curve 700 of the examinee 10 by multiplying the directions and magnitudes of the respective control vectors of the first to Nth interpolation curves by the respective weights, and then adding the multiplied values. However, the motion tracking unit 220 is not limited thereto.

$$\frac{{P}_{n}^{\overline{C}} - {P}_{n - 1}^{\overline{C}}}{‖ {P}_{n}^{\overline{C}} - {P}_{n - 1}^{\overline{C}} ‖} = {w}_{0} \frac{{P}_{n}^{{C}_{0}} - {P}_{n - 1}^{{C}_{0}}}{‖ {P}_{n}^{{C}_{0}} - {P}_{n - 1}^{{C}_{0}} ‖} + {w}_{1} \frac{{P}_{n}^{{C}_{1}} - {P}_{n - 1}^{{C}_{1}}}{‖ {P}_{n}^{{C}_{1}} - {P}_{n - 1}^{{C}_{1}} ‖} + {w}_{2} \frac{{P}_{n}^{{C}_{2}} - {P}_{n - 1}^{{C}_{2}}}{‖ {P}_{n}^{{C}_{2}} - {P}_{n - 1}^{{C}_{2}} ‖} + … + {w}_{N} \frac{{P}_{n}^{{C}_{N}} - {P}_{n - 1}^{{C}_{N}}}{‖ {P}_{n}^{{C}_{N}} - {P}_{n - 1}^{{C}_{N}} ‖} \qquad ( 6 )$$

In Equation 6, the direction of the control vector of the interpolation curve 700 of the examinee 10 is calculated. Further, Pₙ_{_{CN}} represents the control points P_{j=0,1,2,3, . . . ,n} of the first to Nth interpolation curves C_{i=0,1,2,3, . . . ,N}. Pₙ^{C} represents the control points P_{j=0,1,2,3, . . . ,n} of the interpolation curve C̅ of the examinee 10. w_{—}1=0, 1, 2, 3, N represents the weights according to the respective distances from the control points of the first to Nth interpolation curves to the mapped point. Accordingly, the direction of the estimated interpolation curve 700 of the examinee 10 may be obtained by multiplying the directions of the first to Nth interpolation curves by the respective weights, and then adding the multiplied values.

∥Pₙ^{C}−Pₙ₋₁^{C}∥=w₀∥Pₙ_{_{C0}}−Pₙ₋₁∥+w₁∥Pₙ_{_{C1}}−Pₙ₋₁_{_{C1}}∥+w₂∥Pₙ_{_{C2}}−Pₙ₋₁_{_{C2}}∥+ . . . +w_{N}∥Pₙ_{_{CN}}−Pₙ₋₁_{_{CN∥}} (7)

In Equation 7, the magnitude of the estimated interpolation curve 700 of the examinee 10 may be obtained by multiplying the magnitudes of the first to Nth interpolation curves by the respective weights, and then adding the multiplied values. However, without being limited to Equations 6 and 7, the motion tracking unit 220 may obtain the control vector of the interpolation curve 700 of the examinee 10 based on the control vectors of the first to Nth interpolation curves and the respective weights, using various methods.

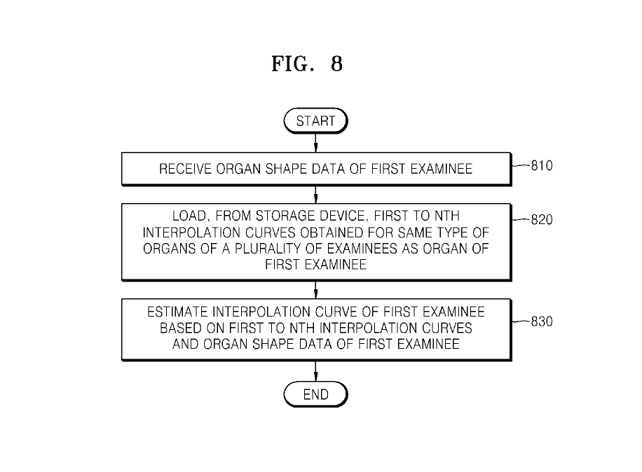

FIG. 8 is a flowchart illustrating an example of a method of tracking motion of an organ. Referring to FIG. 8, the method of tracking the motion of the organ includes operations that are time serially performed by the organ tracking device 100 illustrated in FIGS. 1 to 7. Therefore, the above descriptions of the organ tracking device 100 illustrated in FIGS. 1 to 7 are also applied to the flowchart of FIG. 8.

In operation 810, the interface unit 210 receives organ shape data of the examinee 10, i.e., a first examinee. The organ shape data of the examinee 10 represents a shape of the organ 20 that is obtained at a moment of the motion of the examinee 10. For example, the organ shape data may be an image of the shape of the organ 20 that is obtained by computed tomography (CT) imaging, magnetic resonance imaging (MRI), or an ultrasonic system, but is not limited thereto.

In operation 820, the motion tracking unit 220 loads, from the storage device 230, first to Nth interpolation curves obtained for the respective same type of organs of the examinees 30 as the organ 20 of the examinee 10. The first to Nth interpolation curves represent spatiotemporal paths of motion of the respective organs of the examinees 30 other than the examinee 10.

For example, the first to Nth interpolation curves of the respective examinees 30 may be generated based on the first to Nth organ motion data 40. Each of the first to Nth organ motion data 40 may include a series of pieces of organ shape data that represent shapes of an organ of one of the examinees that are obtained at respective moments of motion of the one of the examinees 30.

In operation 830, the motion tracking unit 220 estimates an interpolation curve of the examinee 10 based on the first to Nth interpolation curves and the organ shape data of the examinee 10.

The examples of the methods, apparatuses, and medical imaging systems described may track spatiotemporal motion of the organ 20 of the examinee 10 based on spatiotemporal paths of motion of respective organs of the plurality of examinees 30 that are stored in the storage device 230, the organs being of the same type as the organ 20 of the examinee 10. Therefore, the motion of the organ 20 of the examinee 10 may be efficiently and safely tracked without repeatedly obtaining a plurality of images of a shape of the organ of respective moments of motion of the examinee 10.

The various units, modules, elements, and methods described above may be implemented using one or more hardware components, one or more software components, or a combination of one or more hardware components and one or more software components.

A software component may be implemented, for example, by a processing device controlled by software or instructions to perform one or more operations, but is not limited thereto. A computer, controller, or other control device may cause the processing device to run the software or execute the instructions. One software component may be implemented by one processing device, or two or more software components may be implemented by one processing device, or one software component may be implemented by two or more processing devices, or two or more software components may be implemented by two or more processing devices.

A processing device may be implemented using one or more general-purpose or special-purpose computers, such as, for example, a processor, a controller and an arithmetic logic unit, a digital signal processor, a microcomputer, a field-programmable array, a programmable logic unit, a microprocessor, or any other device capable of running software or executing instructions. The processing device may run an operating system (OS), and may run one or more software applications that operate under the OS. The processing device may access, store, manipulate, process, and create data when running the software or executing the instructions. For simplicity, the singular term “processing device” may be used in the description, but one of ordinary skill in the art will appreciate that a processing device may include multiple processing elements and multiple types of processing elements. For example, a processing device may include one or more processors, or one or more processors and one or more controllers. In addition, different processing configurations are possible, such as parallel processors or multi-core processors.

A processing device configured to implement a software component to perform an operation A may include a processor programmed to run software or execute instructions to control the processor to perform operation A. In addition, a processing device configured to implement a software component to perform an operation A, an operation B, and an operation C may have various configurations, such as, for example, a processor configured to implement a software component to perform operations A, B, and C; a first processor configured to implement a software component to perform operation A, and a second processor configured to implement a software component to perform operations B and C; a first processor configured to implement a software component to perform operations A and B, and a second processor configured to implement a software component to perform operation C; a first processor configured to implement a software component to perform operation A, a second processor configured to implement a software component to perform operation B, and a third processor configured to implement a software component to perform operation C; a first processor configured to implement a software component to perform operations A, B, and C, and a second processor configured to implement a software component to perform operations A, B, and C, or any other configuration of one or more processors each implementing one or more of operations A, B, and C. Although these examples refer to three operations A, B, C, the number of operations that may implemented is not limited to three, but may be any number of operations required to achieve a desired result or perform a desired task.

Software or instructions for controlling a processing device to implement a software component may include a computer program, a piece of code, an instruction, or some combination thereof, for independently or collectively instructing or configuring the processing device to perform one or more desired operations. The software or instructions may include machine code that may be directly executed by the processing device, such as machine code produced by a compiler, and/or higher-level code that may be executed by the processing device using an interpreter. The software or instructions and any associated data, data files, and data structures may be embodied permanently or temporarily in any type of machine, component, physical or virtual equipment, computer storage medium or device, or a propagated signal wave capable of providing instructions or data to or being interpreted by the processing device. The software or instructions and any associated data, data files, and data structures also may be distributed over network-coupled computer systems so that the software or instructions and any associated data, data files, and data structures are stored and executed in a distributed fashion.

For example, the software or instructions and any associated data, data files, and data structures may be recorded, stored, or fixed in one or more non-transitory computer-readable storage media. A non-transitory computer-readable storage medium may be any data storage device that is capable of storing the software or instructions and any associated data, data files, and data structures so that they can be read by a computer system or processing device. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, or any other non-transitory computer-readable storage medium known to one of ordinary skill in the art.

Functional programs, codes, and code segments for implementing the examples disclosed herein can be easily constructed by a programmer skilled in the art to which the examples pertain based on the drawings and their corresponding descriptions as provided herein.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A method of tracking motion of an organ, the method comprising:
receiving organ shape data that comprises a shape of an organ of an examinee at a moment of motion of the examinee;
loading first to Nth interpolation curves that represent spatiotemporal motion of respective organs of other examinees, the organs of the other examinees being the same type as the organ of the examinee; and
estimating an interpolation curve that represents a spatiotemporal motion of the organ of the examinee based on the first to Nth interpolation curves and the organ shape data.

2. The method of claim 1, wherein the estimating of the interpolation curve comprises:
mapping the shape of the organ at the moment of the motion of the examinee, to a point in an M-dimensional spatiotemporal space;
calculating weights of respective points of the first to Nth interpolation curves based on respective distances from the mapped point to the points in the M-dimensional spatiotemporal space; and
estimating the interpolation curve from the mapped point based on the weights.

3. The method of claim 2, wherein the estimating of the interpolation curve comprises:
calculating first-order to nth-order differential values of the respective points of the first to Nth interpolation curves;
calculating first-order to nth-order differential values of the mapped point based on the first-order to nth-order differential values of the respective points and the weights; and
estimating the interpolation curve based on the first-order to nth-order differential values of the mapped point.

4. The method of claim 2, wherein the estimating of the interpolation curve comprises:
calculating control vectors that connect control points of the respective first to Nth interpolation curves;
calculating a control vector of the interpolation curve based on the control vectors of the first to Nth interpolation curves and the weights; and
estimating the interpolation curve based on the control vector of the interpolation curve.

5. The method of claim 2, wherein the mapping of the shape of the organ comprises:
representing the shape of the organ at the moment of the motion of the examinee, as a linear combination of an M number of basis functions;
obtaining vector coefficients of each of the M number of the basis functions; and
representing combinations of the vector coefficients as the point in the M-dimensional spatiotemporal space.

6. The method of claim 5, wherein the basis functions comprise spherical harmonics.

7. The method of claim 1, further comprising:
obtaining the first to Nth interpolation curves based on first to Nth organ motion data that comprise the motion of the respective organs of the other examinees based on motion of the respective other examinees.

8. The method of claim 1, wherein:
the motion of the examinee is respiration; and
the motion of the respective organs of the other examinees based on motion of the respective other examinees is deformation of the respective organs of the other examinees based on respiration of the respective other examinees.

9. A non-transitory computer-readable storage medium storing a program comprising instructions to cause a computer to perform the method of claim 1.

10. A device configured to track motion of an organ, comprising:
an interface unit configured to receive organ shape data that comprises a shape of an organ of an examinee at a moment of motion of the examinee;
a storage device configured to store first to Nth interpolation curves that represent spatiotemporal motion of respective organs of other examinees, the organs of the other examinees being the same type as the organ of the examinee; and
a motion tracking unit configured to estimate an interpolation curve that represents a spatiotemporal motion of the organ of the examinee based on the first to Nth interpolation curves and the organ shape data.

11. The device of claim 10, wherein the motion tracking unit comprises:
a first mapping unit configured to map the shape of the organ at the moment of the motion of the examinee, to a point in an M-dimensional spatiotemporal space; and
an estimation unit configured to
calculate weights of respective points of the first to Nth interpolation curves based on respective distances from the mapped point to the points in the M-dimensional spatiotemporal space, and
estimate the interpolation curve from the mapped point based on the weights.

12. The device of claim 11, wherein the motion tracking unit further comprises:
a calculation unit configured to calculate first-order to nth-order differential values of the respective points of the first to Nth interpolation curves,
wherein the estimation unit is configured to
calculate first-order to nth-order differential values of the mapped point based on the first-order to nth-order differential values of the respective points and the weights, and
estimate the interpolation curve based on the first-order to nth-order differential values of the mapped point.

13. The device of claim 11, wherein the motion tracking unit further comprises:
a calculation unit configured to calculate control vectors that connect control points of the respective first to Nth interpolation curves,
wherein the estimation unit is configured to
calculate a control vector of the interpolation curve based on the control vectors of the first to Nth interpolation curves and the weights, and
estimate the interpolation curve based on the control vector of the interpolation curve.

14. The device of claim 11, wherein the first mapping unit is configured to:
represent the shape of the organ at the moment of the motion of the examinee, as a liner combination of an M number of basis functions;
obtain vector coefficients of each of the M number of basis functions; and
represent combinations of the vector coefficients as the point in the M-dimensional spatiotemporal space.

15. The device of claim 10, wherein the motion tracking unit comprises:
a matching unit configured to match organ deformation data that comprise a three-dimensional shape of the organ of the examinee that deforms over time, to an image of the organ of the examinee,
wherein
the interface unit is configured to receive the image of the organ of the examinee, and
the motion tracking unit is further configured to
obtain the organ deformation data based on the interpolation curve, and
track the motion of the organ of the examinee based on an image obtained as a result of the matching.

16. The device of claim 10, further comprising:
a motion analysis unit configured to obtain the first to Nth interpolation curves based on first to Nth organ motion data that comprise the motion of the respective organs of the other examinees based on motion of the respective other examinees,
wherein each of the first to Nth organ motion data comprises a series of pieces of organ shape data that comprise shapes of an organ of one of the other examinees at respective moments of motion of the one of the other examinees.

17. The device of claim 16, wherein the motion analysis unit comprises:
a second mapping unit configured to map shapes of the respective organs at moments of the motion of the other examinees, included in the first to Nth organ motion data, to respective points in an M-dimensional spatiotemporal space; and
an interpolation unit configured to obtain the first to Nth interpolation curves by interpolating the respective mapped points.

18. The device of claim 17, wherein the second mapping unit is configured to:
represent the shapes of the respective organs at the moments of the motion of the other examinees, as respective linear combinations of an M number of basis functions;
obtain vector coefficients of each of the M number of basis functions; and
represent combinations of the vector coefficients as the respective points in the M-dimensional spatiotemporal space.

19. A medical imaging device comprising:
an image acquisition device configured to acquire an image of a shape of an organ of an examinee at a moment of motion of the examinee;
an organ tracking device configured to
store first to Nth interpolation curves that represent spatiotemporal motion of respective organs of other examinees, the organs of the other examinees being the same type as the organ of the examinee,
estimate an interpolation curve that represents a spatiotemporal motion of the organ of the examinee based on the first to Nth interpolation curves and the image, and
obtain organ deformation data that comprise a three-dimensional (3D) shape of the organ of the examinee that deforms over time based on the interpolation curve; and
an image display device configured to display the 3D shape of the organ based on the organ deformation data.
